(19) United States
(12) Patent Application Publication
(10) Pub. No.: US 2005/0237274 A1
(43) Pub. Date: Oct. 27, 2005

(54) Plasma display apparatus and method for driving the same

(75) Inventor: Seong Hak Moon, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/109,810

(22) Filed: Apr. 20, 2005

(30) Foreign Application Priority Data
Apr. 21, 2004 (KR) 10-2004-0027634
Apr. 21, 2004 (KR) 10-2004-0027635

(51) Int. Cl. G09G 3/28

(52) U.S. Cl. 345/60

(57) ABSTRACT

The present invention relates to a plasma display apparatus and method for driving the same. According to an aspect of the present invention, the plasma display apparatus includes a plasma display panel, and a scan driving unit and a sustain driving unit respectively including a sustain driving circuit for allowing a peaking pulse to be included in one sustain pulse in such a manner that a plurality of discharge is generated by means of one sustain pulse when a sustain pulse is applied to a predetermined electrode of the plasma display panel. Accordingly, a peaking pulse as LC resonance is applied together with a sustain voltage. Therefore, the present invention is advantageous in that it can save power consumption and improve the brightness.

### CROSS-REFERENCE TO RELATED APPLICATIONS

This Nonprovisional application claims priority under 35 U.S.C. § 119(a) on Patent Application No. 10-2004-0027634 filed in Korea on Apr. 21, 2004 and Patent Application No. 10-2004-0027635 filed in Korea on Apr. 21, 2004, the entire contents of which are hereby incorporated by reference.

### BACKGROUND OF THE INVENTION

1. Field of the Invention

The present invention relates to a plasma display apparatus and method for driving the same.

2. Background of the Related Art

Generally, a plasma display panel (hereinafter, referred to as a “PDP”) is adapted to display an image including characters or graphics by light-emitting phosphors with ultraviolet of 147 nm generated during the discharge of an inert mixed gas such as He+Xe or Ne+Xe.

FIG. 1 is a perspective view illustrating the construction of a conventional three-electrode AC surface discharge type PDP having the structure of discharge cells arranged in the matrix form.

Referring to FIG. 1, the three-electrode AC surface discharge type PDP 100 includes a scan electrode 11a and a sustain electrode 12a which are formed on a bottom surface of an upper substrate 10, and an address electrode 22 formed on a lower substrate 20. The scan electrode 11a and the sustain electrode 12a are formed of transparent electrodes, e.g., indium-tin-oxide (ITO). The scan electrode 11a and the sustain electrode 12a include metal bus electrodes 11b and 12b for reducing resistance, respectively. On the upper substrate 10 on which the scan electrode 11a and the sustain electrode 12a are formed are laminated an upper dielectric layer 13a and a protection film 14. The upper dielectric layer 13a is accumulated with a wall charge generated during plasma discharging. The protective layer 14 serves to prevent damages of the upper dielectric layer 13a due to sputtering caused during plasma discharging, and improve efficiency of secondary electron emission. As the protective layer 14, magnesium oxide (MgO) is generally used.

Meanwhile, a lower dielectric layer 13b and barrier ribs 21 are formed on the lower substrate 20 in which the address electrode 22 is formed. A phosphor layer 23 is coated on the surfaces of both the lower dielectric layer 13b and the barrier ribs 21. The address electrode 22 is formed in a direction in which it crosses the scan electrode 11a and the sustain electrode 12a. The barrier ribs 21 are formed parallel to the address electrode 22, and serve to prevent ultraviolet and visible light, which is generated upon discharging, from leaking toward adjacent discharge cells. The phosphor layer 23 is excited by ultraviolet light generated upon plasma discharging to generate one of red (R), green (G) and blue (B) visible light. An inert mixed gas, such as He+Xe or Ne+Xe, for discharging is injected into discharge spaces of the discharge cells, which are defined between the upper substrate 10 and the barrier ribs 21 and between the lower substrate 20 and the barrier ribs 21. A method for driving the conventional PDP constructed above will now be described with reference to FIG. 2.

FIG. 2 shows a driving waveform for explaining a method for driving the PDP in the prior art. Referring to FIG. 2, the conventional PDP is driven with it being divided into a reset period for initializing the entire screen, an address period for selecting a cell, and a sustain period for sustaining discharging of a selected cell.

The reset period is driven with it being divided into a set-up period SU and a set-down period SD. In the set-up period SU, a ramp-up waveform Ramp-up is applied to the entire scan electrodes at the same time. A discharge is generated within cells of the entire screen by means of the ramp-up waveform. The set-up discharge causes wall charges of the positive polarity to be accumulated on the address electrode X and the sustain electrodes Z, and wall charges of the negative polarity to be caused on the scan electrode Y.

In the set-down period SD, a ramp-down waveform Ramp-down, which falls from a positive voltage lower than a peak voltage of the ramp-up waveform to a ground voltage GND or a predetermined negative voltage, causes a weak erase discharge to occur within cells, thus erasing some of wall charges that are excessively formed. The set-down discharge also causes wall charges of the degree that an address discharge can be generated in a stable manner to uniformly remain within the cells.

In the address period, while a negative scan pulse scan is sequentially applied to the scan electrode Y, a positive data pulse data is applied to the address electrode X in synchronization with the scan pulse. As a voltage difference between the scan pulse and the data pulse and a wall voltage generated in the reset period are added, an address discharge is generated within cells to which the data pulse is applied. Furthermore, wall charges of the degree that can cause a discharge to be generated when a sustain voltage is applied are formed within cells selected by the address discharge.

To the sustain electrode Z is applied a positive DC voltage Zdc, which prevents generation of erroneous discharge with the scan electrodes Y through reduction of a voltage difference with the scan electrodes Y during the set-down period SD and the address period.

In the sustain period, the sustain signal sus is alternately applied to the scan electrode Y and the sustain electrode Z. In cells selected by the address discharge, a sustain discharge, i.e., a display discharge is generated between the scan electrode Y and the sustain electrode Z whenever the sustain pulse is applied as the wall voltage within the cells and the sustain pulse are added. Furthermore, after the sustain discharge is completed, a ramp waveform Ramp-ers, which has a small pulse width and a low voltage, is applied to the sustain electrode Z, thus erasing wall charges remaining within the cells of the entire screen.

Meanwhile, the waveform of the sustain pulse applied to the scan electrode or the sustain electrode during the sustain period, and a sustain driving circuit for generating the waveform will be below described with reference to FIGS. 3 and 4.

FIG. 3 is a circuit diagram of a conventional sustain driving circuit. FIG. 4 shows a typical sustain pulse waveform.

Referring to FIGS. 3 and 4, a first switch Q1 and a fourth switch Q4 are turned on, and a second switch Q2 and a third switch Q3 are turned off. As a voltage source Vs is applied to the electrode Y, a voltage of Vy becomes Vs, the electrode Z becomes a ground level, and Vz thus becomes Ov. In this case, the current applied by a voltage source Vs flows through the first switch Q1, a panel C and the fourth switch Q4.

Thereafter, the third switch Q3 and the second switch Q2 are turned on, and the first switch Q1 and the fourth switch Q4 are turned off. As charge charged into the panel C is discharged through the second switch Q2 and the voltage source Vs is applied to the electrode Z, a voltage of Vz becomes Vs, the electrode Y becomes a ground level, and Vy thus becomes Ov. In this case, the current applied by the voltage source Vs flows through the third switch Q3, the panel C and the second switch Q2.

In the conventional driving apparatus and method for driving the same, charge injected from the voltage source Vs is discharged into the ground through the second switch Q2 or the fourth switch Q4 while the driving apparatus operates. Thus, energy efficiency is very low. As such, higher energy has to be used in order to increase the brightness of the conventional driving apparatus. Accordingly, there is a problem in that energy efficiency is further lowered.

Meanwhile, a conventional method of representing image gray scales in a PDP will be below described with reference to FIG. 5.

FIG. 5 is a view for explaining a method for implementing image gray scales of a PDP in the prior art.

As shown in FIG. 5, in order to represent the image gray scales in the conventional PDP, one frame is divided into a plurality of sub-fields having a different number of emission. Each of the sub-fields is subdivided into a reset period RPD for initializing the entire cells, an address period APD for selecting cells to be discharged, and a sustain period SPD for implementing gray scales according to the number of discharge. For example, if it is desired to display an image with 256 gray scales, a frame period (16.67 ms) corresponding to 1/60 seconds is divided into eight sub-fields SF1 to SF8, as shown in FIG. 5. Each of the eight sub-fields SF1 to SF8 is subdivided into the reset period, the address period and the sustain period.

The reset period and the address period of each of the sub-fields are the same every sub-field. Address discharge for selecting cells to be discharged is generated due to a voltage difference between address electrodes and transparent electrodes being scan electrodes. The sustain period increases in the ratio of 2ⁿ (where, n=0,1,2,3,4,5,6,7) in each of the sub-fields. As such, since the sustain period varies in each sub-field, gray scales of an image are represented by controlling the sustain period of each of the sub-fields, i.e., the number of sustain discharges.

As such, each gray scale is represented by a combination of sub-fields, and the number of sustain pulses allocated to each sub-field varies depending upon weight of the sub-field.

In this case, if the load proportional to the number of cells that are turned on increases, the amount of voltage drop of the same sustain voltage increases. That is, assuming that the sustain voltage is 100 V, a voltage that is actually applied to the scan electrode Y or the sustain electrode Z is lower than 100 V depending upon voltage drop. The greater the load, the higher the amount of voltage drop. Accordingly, since the amount of sustain voltage is constant although the number of sustain pulses is increased to compensate for reduced brightness, the amount of voltage drop per one sustain pulse is constant. As a result, there is a problem in that a brightness, which is compensated for compared to consumed power, reduces as the number of sustain pulses increases.

### SUMMARY OF THE INVENTION

Accordingly, the present invention has been made in view of the above problems, and it is an object of the present invention to provide a plasma display apparatus and method for driving the same, wherein both energy efficiency and brightness can be increased, and the amount of a sustain voltage can also be controlled depending upon the amount of load.

Another object of the present invention is to provide a plasma display apparatus and method for driving the same, wherein the amount of a sustain voltage can be controlled depending upon the amount of load, and brightness and contrast can also be increased through formation of a peaking pulse.

To achieve the above objects, according to an aspect of the present invention, there is provided a plasma display apparatus, including a plasma display panel, and a scan driving unit and a sustain driving unit respectively including a sustain driving circuit for allowing a peaking pulse to be included in one sustain pulse in such a manner that a plurality of discharge is generated by means of one sustain pulse when a sustain pulse is applied to a predetermined electrode of the plasma display panel.

According to another aspect of the present invention, there is provided a method of driving a plasma display apparatus, including the steps of converting an input picture signal to be suitable for a PDP, and forming picture data that are re-aligned on a sub-field basis, measuring the amount of load using the picture data re-aligned on a sub-field basis, which are received from a controller unit, comparing the amount of the measured load and the amount of reference load to output a voltage control signal, and deciding a sustain voltage corresponding to the sustain voltage control signal, and applying the decided sustain voltage to a scan electrode or a sustain electrode of the PDP.

### BRIEF DESCRIPTION OF THE DRAWINGS

Further objects and advantages of the invention can be more fully understood from the following detailed description taken in conjunction with the accompanying drawings in which:

FIG.1 is a perspective view illustrating the construction of a conventional three-electrode AC surface discharge type PDP having the structure of discharge cells arranged in the matrix form;

FIG. 2 shows a driving waveform for explaining a method of driving the PDP in the prior art;

FIG. 3 is a circuit diagram of a typical sustain driving circuit;

FIG. 4 shows a typical sustain pulse waveform;

FIG. 5 is a view for explaining a method for implementing image gray scales of a PDP in the prior art;

FIG. 6 is a schematic view illustrating the configuration of a first plasma display apparatus according to the present invention;

FIG. 7 is a circuit diagram of a sustain driving circuit included in a scan driving unit and a sustain driving unit according to the present invention;

FIG. 8 shows a pulse waveform generated by the operation of the sustain driving circuit according to the present invention;

FIG. 9 is a schematic view illustrating the configuration of a second plasma display apparatus according to the present invention;

FIG. 10 is a circuit diagram of a sustain driving circuit included in a scan driving unit and a sustain driving unit for explaining a first driving method of the second plasma display apparatus according to the present invention;

FIG. 11 shows a driving waveform generated by the sustain driving circuit included in the scan driving unit and the sustain driving unit of FIG. 10;

FIG. 12 shows another driving waveform generated by the sustain driving circuit included in the scan driving unit and the sustain driving unit of FIG. 10;

FIG. 13 is a circuit diagram of a sustain driving circuit included in a scan driving unit and a sustain driving unit for explaining a second driving method of the second plasma display apparatus according to the present invention;

FIG. 14 shows a driving waveform generated by the sustain driving circuit included in the scan driving unit and the sustain driving unit of FIG. 13; and

FIG. 15 shows another driving waveform generated by the sustain driving circuit included in the scan driving unit and the sustain driving unit of FIG. 13.

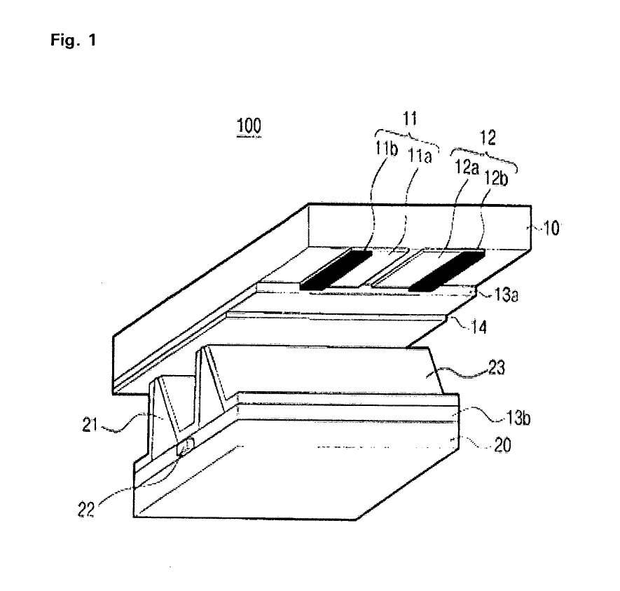

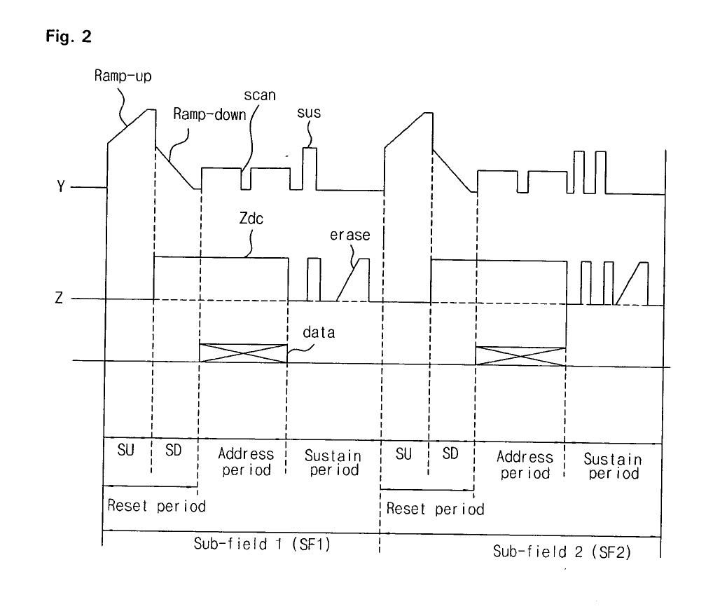

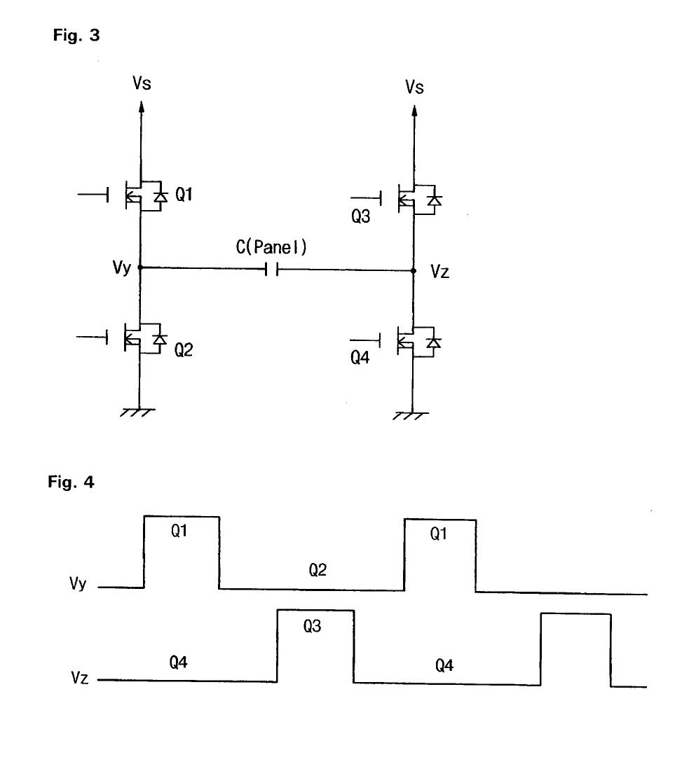

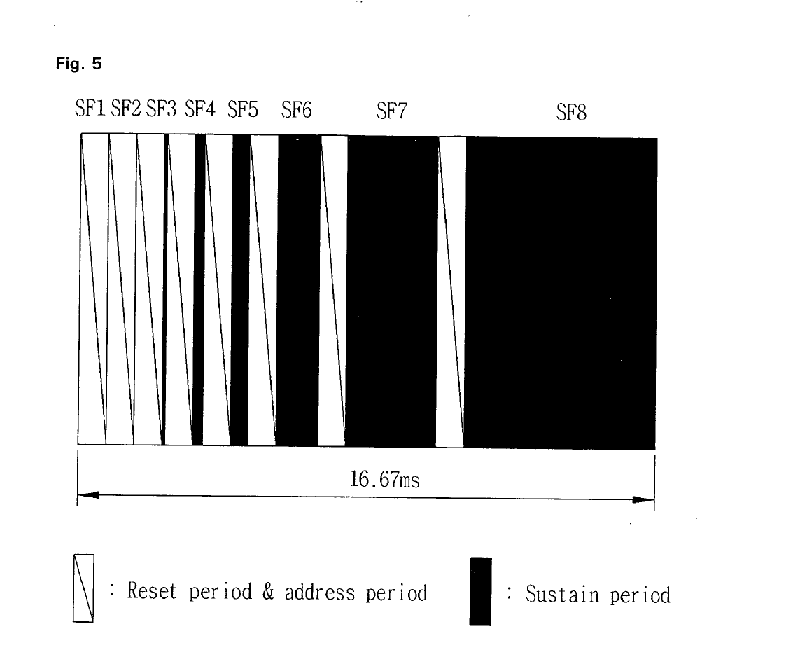

### DETAILED DESCRIPTION OF THE PREFERRED EMBODIMENT

The present invention will now be described in detail in connection with preferred embodiments with reference to the accompanying drawings.

According to an aspect of the present invention, there is provided a plasma display apparatus, including a plasma display panel, and a scan driving unit and a sustain driving unit respectively including a sustain driving circuit for allowing a peaking pulse to be included in one sustain pulse in such a manner that a plurality of discharge is generated by means of one sustain pulse when a sustain pulse is applied to a predetermined electrode of the plasma display panel.

The predetermined electrode of the plasma display panel is preferably at least one of scan electrodes and sustain electrodes.

The sustain driving circuit can include a peaking pulse application unit having a switch for peaking pulse, which is turned on when energy of an energy storage unit is supplied to the plasma display panel, and a diode for injecting energy to the energy storage unit, a resonant unit which forms a peaking pulse as LC resonance using the energy of the energy storage unit, and applies the formed LC resonance to the scan electrode or the sustain electrode, and a sustain voltage controller that applies a sustain voltage to the scan electrode or the sustain electrode or sustains a ground level.

The peaking pulse can be applied to the scan electrode or the sustain electrode before a sustain voltage is applied.

The switch for peaking pulse has a gate terminal that receives a timing signal, a drain terminal connected to the energy storage unit, and a source terminal connected to an anode terminal of the diode, and the diode has a cathode terminal connected to the drain terminal of the switch for peaking pulse, and the anode terminal connected to the source terminal of the switch for peaking pulse.

A voltage of the peaking pulse is higher than the sustain voltage.

The resonant unit includes a coil, wherein the coil has one end connected to the source terminal of the switch for peaking pulse and the other end connected to the scan electrode or the sustain electrode.

The plasma display apparatus can further include a load measurement unit for measuring the amount of load of picture data, which are converted to be suitable for the PDP, and comparing the amount of the measured load and the amount of reference load to output a voltage control signal, and a voltage controller for controlling a sustain voltage according to the voltage control signal output from the load measurement unit, and applying the controlled sustain voltage to a scan electrode or a sustain electrode of the PDP.

The voltage controller can apply a voltage higher than the sustain reference voltage to the scan electrode or the sustain electrode of the PDP if the amount of the measured load is higher than the amount of reference load.

The plasma display apparatus can further include a sustain pulse controller for, if the amount of the measured load is higher than the amount of reference load, receiving a sustain pulse control signal from the load measurement unit, and controlling the number of sustain pulses, which is already allocated. In this case, the sustain pulse controller controls the scan driving unit and the sustain driving unit to apply the sum of the reference sustain voltage and an increment value of the sustain voltage, when controlling the scan driving unit and the sustain driving unit to apply the sustain pulse to the scan electrode or the sustain electrode.

The voltage controller controls the reference sustain voltage to be applied to the scan electrode or the sustain electrode if the amount of the measured load is lower than the amount of reference load.

The voltage controller can include a DC/DC converter, wherein the DC/DC converter decides the increment value of the sustain voltage according to a pulse width of a sustain voltage control signal.

According to another aspect of the present invention, there is provided a method of driving a plasma display apparatus, including the steps of converting an input picture signal to be suitable for a PDP, and forming picture data that are re-aligned on a sub-field basis, measuring the amount of load using the picture data re-aligned on a sub-field basis, which are received from a controller unit, comparing the amount of the measured load and the amount of reference load to output a voltage control signal, and deciding a sustain voltage corresponding to the sustain voltage control signal, and applying the decided sustain voltage to a scan electrode or a sustain electrode of the PDP.

If the amount of the measured load is higher than the amount of reference load, the number of sustain pulses that is already allocated is controlled.

The method can further include the step of applying the reference sustain voltage to a scan electrode or a sustain electrode if the amount of the measured load is lower than the amount of reference load.

The step of applying the decided sustain voltage to the scan electrode or the sustain electrode includes the steps of while previously stored energy is injected, controlling a peaking pulse that is formed by way of LC resonance to be applied to the scan electrode, after the peaking pulse is applied, controlling a sustain voltage to be applied to the scan electrode, and the sustain electrode to become a ground level, while previously stored energy is injected, controlling the peaking pulse that is formed by way of LC resonance to be applied to the scan electrode, and after the peaking pulse is applied, controlling a sustain voltage to be applied to the sustain electrode, and the scan electrode to become a ground level.

The sustain voltage is applied when a voltage of the peaking pulse reaches a highest value.

A voltage of the peaking pulse is higher than the sustain voltage.

Discharges are generated by the peaking pulse.

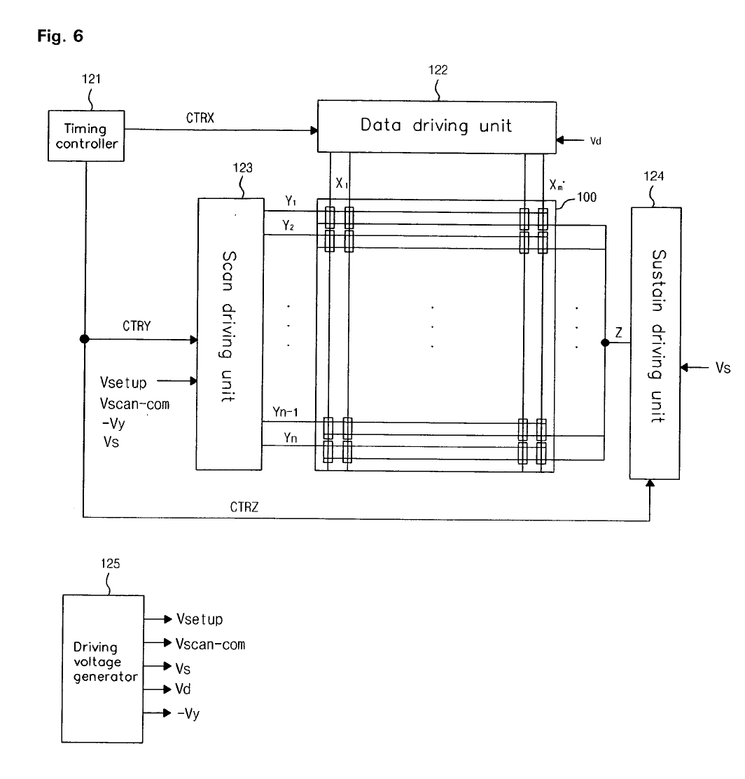

FIG. 6 is a schematic view illustrating the configuration of a first plasma display apparatus according to the present invention.

Referring to FIG. 6, the first plasma display apparatus according to the present invention includes a PDP 100, a data driving unit 122 for supplying data to address electrodes X1 to Xm formed in a lower substrate (not shown) of the PDD 100, a scan driving unit 123 for driving scan electrodes Y1 to Yn, a sustain driving unit 124 for driving a sustain electrode Z being a common electrode, a timing controller 121 for controlling the data driving unit 122, the scan driving unit 123 and the sustain driving unit 1 24 when the PDP operates, and a driving voltage generator 125 for supplying driving voltages necessary for the driving units 122, 123 and 124.

In the PDP 100, an upper substrate (not shown) and a lower substrate (not shown) are combined together with a predetermined distance therebetween. A plurality of electrodes, e.g., the scan electrodes Y1 to Yn and the sustain electrode Z is formed in pairs in the upper substrate. The address electrodes X1 to Xm are formed in the lower substrate in such a way to cross the scan electrodes Y1 to Yn and the sustain electrode Z.

To the data driving unit 122 are supplied data, which undergo inverse gamma correction, error diffusion, etc. by means of an inverse gamma correction circuit (not shown), an error diffusion circuit (not shown), etc., and are then mapped to respective sub-fields by means of a sub-field mapping circuit. This data driving unit 122 samples and latches data in response to a timing control signal CTRX from the timing controller 121, and supplies the data to the address electrodes X1 to Xm.

The scan driving unit 123 applies a ramp-up waveform Ramp-up and a ramp-down waveform Ramp-down to the scan electrodes Y1 to Yn under the control of the timing controller 121 during a reset period. The scan driving unit 123 also sequentially applies a scan pulse Sp of a scan voltage −Vy to the scan electrodes Y1 to Yn under the control of the timing controller 121 during an address period, and supplies a sustain pulse generated by an internal sustain driving circuit to the scan electrodes during a sustain period. In this case, one sustain pulse includes a peaking pulse, and generates a plurality of discharge.

The sustain driving unit 124 applies a bias voltage of a sustain voltage Vs to the sustain electrodes Z during a period where the ramp-down waveform Ramp-down is generated and during the address period under the control of the timing controller 121. An internal sustain driving circuit provided within the sustain driving unit 124 alternately operates with a sustain driving circuit provided within the scan driving unit 123 to supply the sustain pulse sus to the sustain electrodes Z during the sustain period. In this case, the one sustain pulse also includes a peaking pulse, and generates a plurality of discharge.

Meanwhile, it has been described above that the peaking pulse is included in all the sustain pulses generated by the sustain driving circuits included in the scan driving unit and the sustain driving unit, and are then applied to the scan electrodes or the sustain electrode. It is, however, to be noted that the peaking pulse can be supplied to the sustain electrode or the scan electrodes, if needed. The peaking pulse can also be included in some of the sustain pulse not all the sustain pulses generated by the sustain driving circuits, and then supplied to the scan electrode or the sustain electrode.

The timing controller 121 receives vertical/horizontal sync signals and a clock signal, generates timing control signals CTRX, CTRY and CTRZ for controlling operating timing and synchronization of the driving units 122, 123 and 124 in the reset period, the address period and the sustain period, and provides the timing control signals CTRX, CTRY and CTRZ to corresponding driving units 122, 123 and 124, thereby controlling the respective driving units 122, 123 and 124.

Meanwhile, the data control signal CTRX includes a sampling clock for sampling data, a latch control signal, and a switch control signal for controlling on/off time of the sustain driving circuit and a driving switch element. The scan control signal CTRY includes a switch control signal for controlling on/off time of the sustain driving circuit and a driving switch element within the scan driving unit 123. The sustain control signal CTRZ includes a switch control signal for controlling on/off time of a sustain driving circuit and a driving switch element within the sustain driving unit 124.

The driving voltage generator 125 generates the set-up voltage Vsetup, the scan common voltage Vscan-com, the scan voltage −Vy, the sustain voltage Vs, the data voltage Vd, and the like. The driving voltages can vary depending upon the composition of a discharge or the structure of a discharge cell.

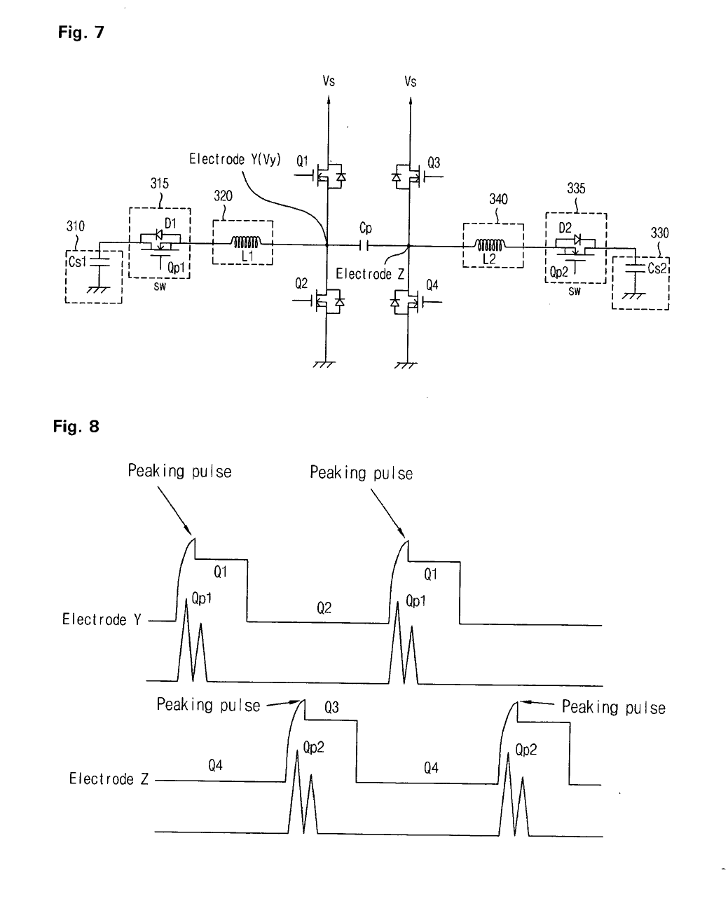

In the plasma display apparatus constructed above, the waveform of the sustain pulses, which are generated by the sustain driving circuit and the sustain driving circuit respectively included in the scan driving unit and the sustain driving unit, will now be described with reference to FIGS. 7 and 8.

FIG. 7 is a circuit diagram of a sustain driving circuit included in a scan driving unit and a sustain driving unit according to the present invention. FIG. 8 shows a pulse waveform generated by the operation of the sustain driving circuit according to the present invention.

Referring first to FIG. 7, the sustain driving circuit included in the scan driving unit (not shown) includes a first energy storage unit 310, a first peaking pulse application unit 315, a first resonant unit 320 and a first sustain voltage controller 325. The sustain driving circuit included in the sustain driving unit (not shown) includes a second energy storage unit 330, a second peaking pulse application unit 335, a second resonant unit 340 and a second sustain voltage controller 345.

First Energy Storage Unit

The first energy storage unit 310 includes a capacitor Cs1 for storing energy necessary to apply a peaking pulse higher than the sustain voltage Vs to the scan electrode.

First Peaking Pulse Application Unit

The first peaking pulse application unit 315 includes a first switch Qp1 for peaking pulse, which is turned on when the first peaking pulse application unit 315 supplies energy received from the first energy storage unit 310 to a panel, and a first diode D1 connected to the first switch Qp1 for peaking pulse in a parallel manner, for injecting energy to the first energy storage unit 310.

In this case, the first switch Qp1 for peaking pulse is a MOSFET, and has a gate terminal for receiving a timing signal and a drain terminal connected to the first energy storage unit 310. Further, the first diode D1 has a cathode terminal connected to the drain terminal of the switch Qp1, and an anode terminal connected to a source terminal of the first switch Qp1 for peaking pulse.

First Resonant Unit

The first resonant unit 320 has a coil L1. It serves to form a peaking pulse higher than the sustain voltage Vs as LC resonance using the energy output from the first energy storage unit 310 before the sustain voltage Vs is applied to the scan electrode of the panel, and apply the formed LC resonance to the scan electrode.

First Sustain Voltage Controller

The first sustain voltage controller 325 includes a first switch Q1 that applies the sustain voltage Vs to the scan electrode, and a second switch Q2 that discharges charge applied to the scan electrode into the ground.

Second Energy Storage Unit

The second energy storage unit 330 includes a capacitor Cs2 that stores energy necessary to apply a peaking pulse higher than the sustain voltage Vs to the sustain electrode.

Second Peaking Pulse Application Unit

The second peaking pulse application unit 335 includes a second switch Qp2 for peaking pulse, which is turned on when the second peaking pulse application unit 335 supplies the energy received from the second energy storage unit 330 to the panel, and a second diode D2 connected to the second switch Qp2 for peaking pulse in a parallel manner, for injecting the energy to the second energy storage unit 330.

In this case, the second switch Qp2 for peaking pulse for peaking pulse is a MOSFET, and has a gate terminal for receiving a timing signal and a drain terminal connected to the second energy storage unit 330. Furthermore, the second diode D2 has a cathode terminal connected to the drain terminal of the second switch Qp2, and an anode terminal connected to a source terminal of the second switch Qp2.

Second Resonant Unit

The second resonant unit 340 includes a coil L2. It serves to form a peaking pulse higher than the sustain voltage Vs as LC resonance using the energy output from the second energy storage unit 330 before the sustain voltage Vs is applied to the scan electrode of the panel, and apply the formed LC resonance to the sustain electrode.

Second Sustain Voltage Controller

The second sustain voltage controller 345 includes a third switch Q3 that applies the sustain voltage Vs to the sustain electrode, and a fourth switch Q4 that discharges charge applied to the sustain electrode into the ground.

The waveform of the sustain pulse, which is generated by the operation of the sustain driving circuit constructed above, will be described with reference to FIG. 8. If the first switch Qp1 for peaking pulse is turned on, energy stored in the capacitor Cs1 of the first energy storage unit 310 is injected into the panel Cp through the coil L1 of the first peaking pulse application unit 315 and the scan electrode Y, and the peaking pulse higher than the sustain voltage is applied to the scan electrode Y by means of LC resonance at the same time.

Thereafter, when the peaking voltage reaches the highest value, the first switch Q1 and the fourth switch Q4 are turned on, and the first switch Qp1 for peaking pulse is turned off. Accordingly, while the sustain voltage Vs is applied to the scan electrode Y and charged into the capacitor Cs1 through the first diode D1, the sustain electrode Z is applied with a ground level.

In this process, twice sustain discharges are generated. That is, when the peaking pulse is applied, the sustain discharge is generated, and when the sustain voltage is applied to the scan electrode Y, the sustain discharge is generated again.

As such, while the energy stored in the first energy storage unit 310 is injected into the panel Cp, the peaking pulse formed by means of LC resonance is applied to the panel Cp. This results in increased energy efficiency and brightness compared to a conventional driving method.

Meanwhile, if the second switch Qp2 for peaking pulse is turned on, energy stored in the capacitor Cs2 of the second energy storage unit 330 is injected into the panel Cp through the coil L2 of the second peaking pulse application unit 335 and the sustain electrode Z. A peaking pulse higher than the sustain voltage is thus applied to the sustain electrode Z by means of LC resonance.

When a peaking voltage reaches the highest value, the third switch Q3 and the second switch Q2 are turned on, and the second switch Qp2 for peaking pulse is turned off. Accordingly, as the sustain voltage Vs is applied to the sustain electrode Z and is also charged into the capacitor Cs2 through the second diode D2, the scan electrode Y is applied with a ground level.

Even in this process, twice sustain discharges are generated. That is, when the peaking pulse is applied, the sustain discharge is generated, and when the sustain voltage is applied to the sustain electrode Z, the sustain discharge is generated again.

As such, while the energy stored in the second energy storage unit 330 is injected into the panel Cp, the peaking pulse formed by means of LC resonance is applied to the panel Cp. This results in increased energy efficiency and brightness compared to a conventional driving method.

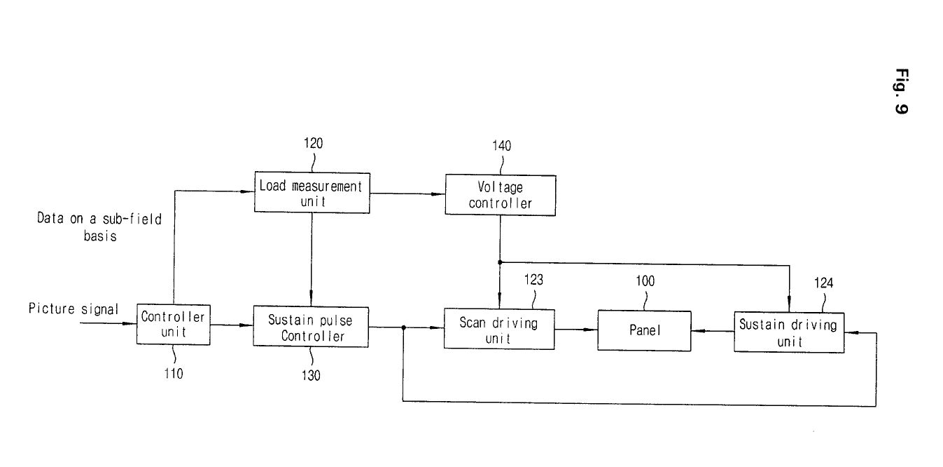

The configuration of a second plasma display apparatus according to the present invention will now be described with reference to FIG. 9.

FIG. 9 is a schematic view illustrating the configuration of the second plasma display apparatus according to the present invention. Referring to FIG. 9, the second plasma display apparatus according to the present invention includes a PDP 100, a controller unit 110, a load measurement unit 120, a sustain pulse controller 130, a voltage controller 140, a scan driving unit 123 and a sustain driving unit 124.

Controller Unit

The controller unit 110 converts an input picture signal to be suitable for a PDP, forms picture data that are realigned on a sub-field basis, and allocates the number of sustain pulses on a sub-field basis.

Load Measurement Unit

The load measurement unit 120 measures the amount of load, which is proportional to the number of cells that are turned on in one frame or one sub-field, by using the picture data that are realigned on a sub-field basis, which are received from the controller unit 110, compares the amount of measured load and the amount of reference load, and if the amount of measured load is higher than the amount of reference load, outputs a sustain pulse control signal and a sustain voltage control signal.

Sustain Pulse Controller

The sustain pulse controller 130 controls a sustain pulse signal according to the number, which is allocated by the controller unit 110, to be applied to the scan driving unit 123 and the sustain driving unit 124 if the sustain pulse control signal is not received from the load measurement unit 120, and controls the sustain pulse signal according to a re-controlled number to be applied to the scan driving unit 123 and the sustain driving unit 124 by re-controlling the number of sustain pulses, if the sustain pulse control signal is received from the load measurement unit 120.

Voltage Controller

The voltage controller 140, if the sustain voltage control signal is received from the load measurement unit 120, decides an increment value of the sustain voltage and then controls the sum of the increment value of the reference sustain voltage and the sustain voltage to be applied to scan electrode Y and sustain electrode Z of the panel according the operation of the scan driving unit 123 and the sustain driving unit 124, and, if the sustain voltage control signal is not received from the load measurement unit 120, controls the reference sustain voltage to be applied to the scan electrode Y and the sustain electrode Z of the panel according to the operation of the scan driving unit 1 23 and the sustain driving unit 124.

In this case, the voltage controller 140 includes a DC/DC converter, and decides the increment value of the sustain voltage depending upon a pulse width of the sustain voltage control signal. That is, the wider the pulse width of the sustain voltage control signal, the higher the increment value of the sustain voltage.

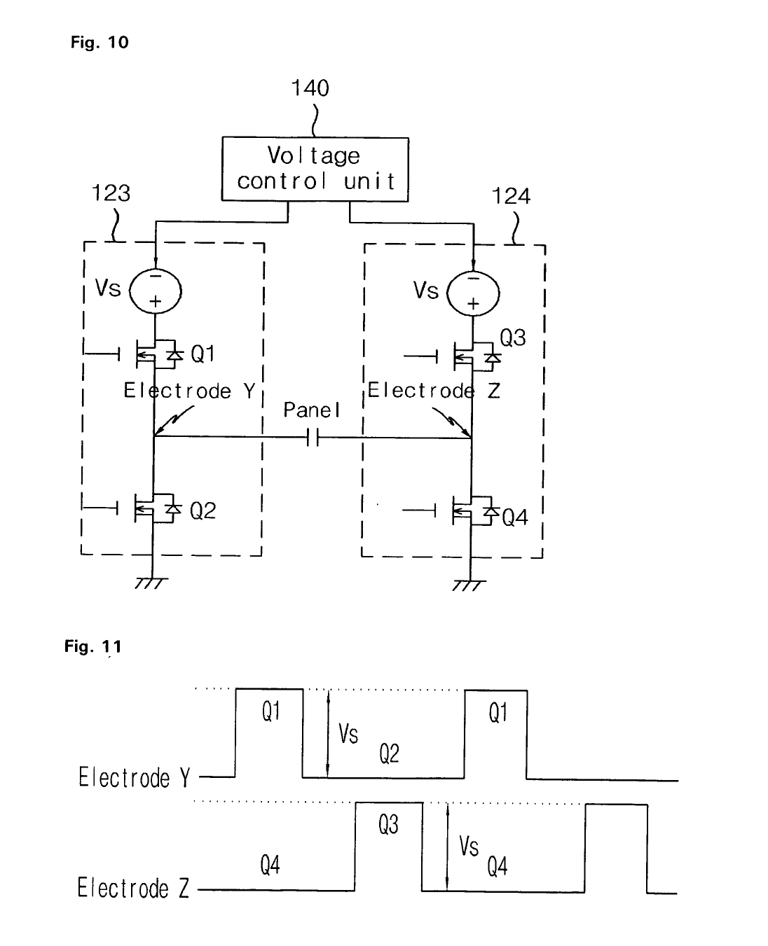

A first driving method of the second plasma display apparatus constructed above will now be described with reference to FIGS. 10, 11 and 12.

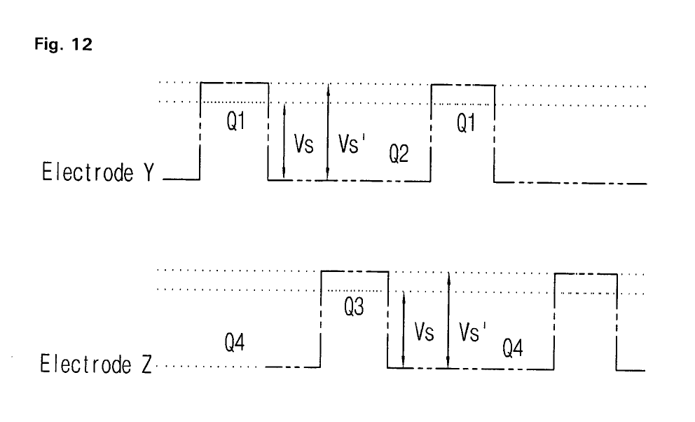

FIG. 10 is a circuit diagram of a sustain driving circuit included in a scan driving unit and a sustain driving unit for explaining the first driving method of the second plasma display apparatus according to the present invention. FIG. 11 shows a driving waveform generated by the sustain driving circuit included in the scan driving unit and the sustain driving unit of FIG. 10. FIG. 12 shows another driving waveform generated by the sustain driving circuit included in the scan driving unit and the sustain driving unit of FIG. 10.

As shown in FIG. 9, the controller unit 110 converts input picture signal to be suitable for the PDP, and allocates the number of sustain pulses on a sub-field basis to picture data that are realigned on a sub-field basis.

The load measurement unit 120 measures the amount of load using the picture data that are realigned on a sub-field basis, which are received form the controller unit 110, and compares the amount of measured load and the amount of reference load.

If it is determined that the amount of measured load is smaller than the amount of reference load by means of the load measurement unit 120, the sustain pulse controller 130 controls the sustain pulse on a sub-field basis according to the number that is allocated by the controller unit 110 to be applied to the scan electrode Y and the sustain electrode Z, and the voltage controller 140 controls a reference sustain voltage Vs to be applied to the scan electrode and the sustain electrodes, as shown in FIG. 11.

This will be described with reference to FIG. 10. In order for the sustain pulse to be applied to the scan electrode Y, a first switch Q1 and a fourth switch Q4 are turned on, and a third switch Q3 and a second switch Q2 are turned on. Accordingly, the reference sustain voltage Vs is applied to the scan electrode Y, and the sustain electrode Z becomes a ground level.

Furthermore, in order for the sustain pulse to be applied to the sustain electrode Z, the third switch Q3 and the second switch Q2 are turned on, and the first switch Q1 and the fourth switch Q4 are turned off. Accordingly, the reference sustain voltage Vs is applied to the sustain electrode Z, and the scan electrode Y becomes a ground level.

Meanwhile, if it is determined that the amount of measured load is higher than the amount of reference load by means of the load measurement unit 120 shown in FIG. 9, the sustain pulse control signal and the sustain voltage control signal are output to the sustain pulse controller 130 and the voltage controller 140, respectively.

The sustain pulse controller 130 that receives the sustain pulse control signal controls the number of sustain pulses again, and controls the scan driving unit 123 and the sustain driving unit 124 to apply the sustain pulse the number of which is re-controlled to the scan electrode Y and the sustain electrode Z, respectively.

On the other hand, the voltage controller 140 that receives the sustain voltage control signal outputs a sustain voltage increment value corresponding to the sustain voltage control signal. Therefore, the sustain voltage applied to the scan electrode Y and the sustain electrode Z becomes the sum Vs′ of the reference sustain voltage Vs and the sustain voltage increment value, as shown in FIG. 12.

This will be described with reference to FIG. 10. In order for the sustain pulse to be applied to the scan electrode Y, the first switch Q1 and the fourth switch Q4 are turned on, and the third switch Q3 and the second switch Q2 are turned on. Accordingly, the sum Vs′ of the reference sustain voltage and the sustain voltage increment value is applied to the scan electrode Y, and the sustain electrode Z becomes a ground level.

Meanwhile, in order for the sustain pulse to be applied to the sustain electrode Z, the third switch Q3 and the second switch Q2 are turned on, and the first switch Q1 and the fourth switch Q4 are turned off. Accordingly, the sum Vs′ of the reference sustain voltage and the sustain voltage increment value is applied to the sustain electrode Z, and the scan electrode Y becomes the ground level.

In the second plasma display apparatus that is driven according to the first driving method, brightness and contrast are increase by increasing the sustain voltage according to the amount of load of input picture data.

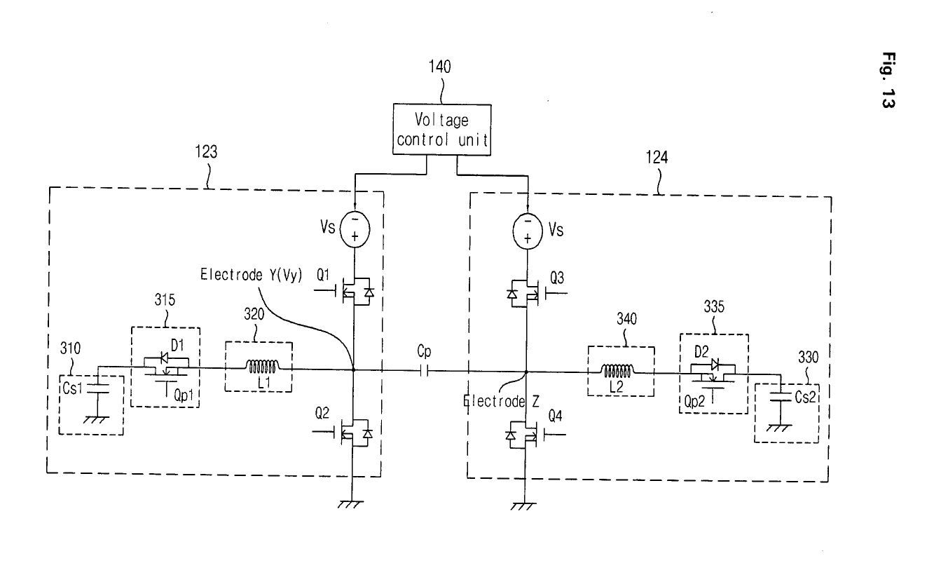

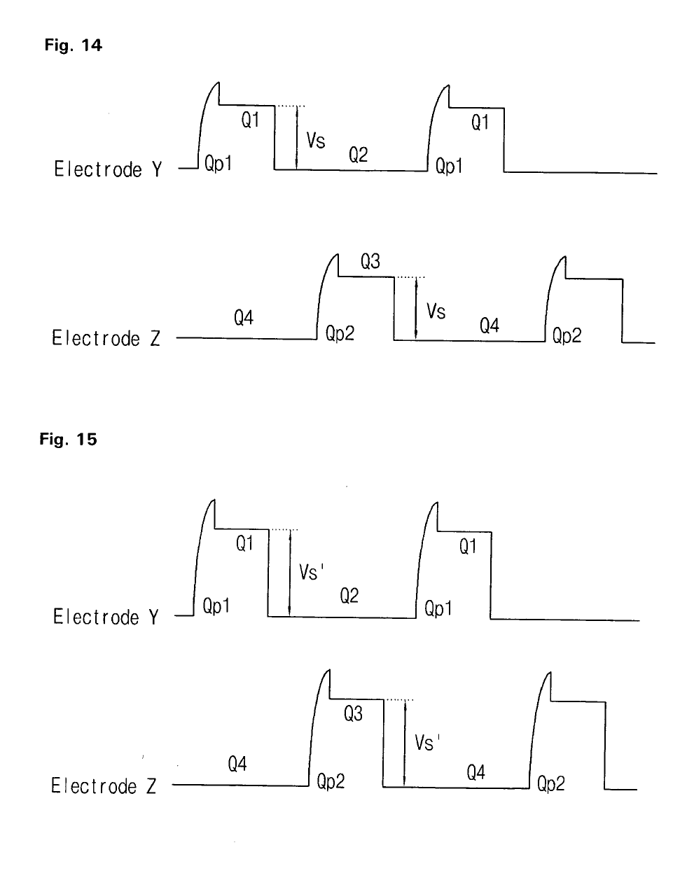

FIG. 13 is a circuit diagram of a sustain driving circuit included in a scan driving unit and a sustain driving unit for explaining a second driving method of the second plasma display apparatus according to the present invention. FIG. 14 shows a driving waveform generated by the sustain driving circuit included in the scan driving unit and the sustain driving unit of FIG. 13. FIG. 15 shows another driving waveform generated by the sustain driving circuit included in the scan driving unit and the sustain driving unit of FIG. 13.

As shown in FIG. 9, the controller unit 110 converts input picture signal to be suitable for the PDP, and allocates the number of sustain pulses on a sub-field basis to picture data that are realigned on a sub-field basis.

The load measurement unit 120 measures the amount of load using the picture data that are realigned on a sub-field basis, which are received form the controller unit 110, and compares the amount of measured load and the amount of reference load.

If it is determined that the amount of measured load is smaller than the amount of reference load by means of the load measurement unit 120, the sustain pulse controller 130 controls the sustain pulse on a sub-field basis according to the number that is allocated by the controller unit 110 to be applied to the scan electrode Y and the sustain electrode Z, and the voltage controller 140 controls a reference sustain voltage Vs to be applied to the scan electrode and the sustain electrodes, as shown in FIG. 14. In this case, the sustain pulse applied to the scan electrode Y and the sustain electrode Z includes a peaking pulse.

This will be described with reference to FIG. 13. If a switch for first peaking pulse Qp1 is turned on, while energy stored in a capacitor Cs1 of a first energy storage unit 510 is injected into a panel Cp via a coil L1 of a first peaking pulse application unit 515 and an electrode Y, a peaking pulse higher than the sustain voltage is applied to the electrode Y by means of LC resonance.

Then, when the peaking voltage reaches a highest value, a first switch Q1 and a fourth switch Q4 are turned on, and the switch for first peaking pulse Qp1 is turned off. Accordingly, while the sustain voltage Vs is applied to the scan electrode Y, the capacitor Cs1 is charged via a first diode D1 and the sustain electrode Z is applied with a ground level.

In this process, twice sustain discharges are generated. That is, a sustain discharge is generated when the peaking pulse is applied, and another sustain discharge is generated when the sustain voltage is applied to the scan electrode Y.

As such, as energy stored in the first energy storage unit 510 is injected into the panel Cp, the peaking pulse formed by way of LC resonance is applied, whereby energy efficiency is improved and brightness is also increased.

On the other hand, if a switch for second peaking pulse Qp2 is turned on, while energy stored in a capacitor Cs2 of a second energy storage unit 530 is injected into the panel Cp through a coil L2 of a second peaking pulse application unit 535 and the electrode Z, a peaking pulse higher than the sustain voltage is applied to the sustain electrode Z by means of LC resonance.

Then, when the peaking voltage reaches a highest value, a third switch Q3 and a second switch Q2 are turned on, and the switch for second peaking pulse Qp2 is turned off. Accordingly, while the sustain voltage Vs is applied to the sustain electrode Z, a capacitor Cs2 is charged through a second diode D2, and the scan electrode Y is applied with the ground level.

Even in this process, twice sustain discharges are generated. That is, a sustain discharge is generated when the peaking pulse is applied, and another sustain discharge is generated when the sustain voltage is applied to the sustain electrode Z.

Meanwhile, if it is determined that the amount of measured load is higher than the amount of reference load by means of the load measurement unit 120 shown in FIG. 9, the sustain pulse control signal and the sustain voltage control signal are output to the sustain pulse controller 130 and the voltage controller 140, respectively.

The sustain pulse controller 130 that receives the sustain pulse control signal controls the number of sustain pulses again, and controls the scan driving unit 123 and the sustain driving unit 124 to apply the sustain pulse the number of which is re-controlled to the scan electrode Y and the sustain electrode Z, respectively.

On the other hand, the voltage controller 140 that receives the sustain voltage control signal outputs a sustain voltage increment value corresponding to the sustain voltage control signal. Therefore, the sustain voltage applied to the scan electrode Y and the sustain electrode Z becomes the sum Vs′ of the reference sustain voltage Vs and the sustain voltage increment value, as shown in FIG. 12. In this case, the sustain pulse applied to the scan electrode Y and the sustain electrode Z includes a peaking pulse.

This will be described with reference to FIG. 13. If the switch for first peaking pulse Qp1 is turned on, while energy stored in the capacitor Cs1 of the first energy storage unit 310 is injected into the panel Cp through the coil L1 of the first peaking pulse application unit 315 and the scan electrode Y, a peaking pulse higher than the sum Vs′ of the reference sustain voltage Vs and the sustain voltage increment value is applied to the scan electrode Y by means of LC resonance.

Next, when the peaking voltage reaches a highest value, the first switch Q1 and the fourth switch Q4 are turned on, and the switch for first peaking pulse Qp1 is turned off. Accordingly, while the sum Vs′ of the reference sustain voltage Vs and the sustain voltage increment value is applied to the scan electrode Y, the capacitor Cs1 is charge through the first diode D1, and the sustain electrode Z is applied with the ground level.

In this process, twice sustain discharges are generated. That is, a sustain discharge is generated when the peaking pulse is applied, and another sustain discharge is generated when the sustain voltage is applied to the scan electrode Y.

As such, in the second plasma display apparatus that is driven according to the second driving method, brightness and contrast can be improved by increasing the sustain voltage according to the amount of load of input picture data. Further, as the peaking pulse is include, energy efficiency can be increased by supplying the sustain pulse to the scan electrode and the sustain electrode.

As described above, according to the present invention, a sustain voltage is controlled according to the amount of load of picture data. Therefore, the present invention is advantageous in that it can improve brightness and contrast characteristics. Further, as a peaking pulse and a sustain pulse are applied at the same time by way of LC resonance, power consumption can be saved and energy efficiency can be improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display apparatus, comprising:
a plasma display panel; and
a scan driving unit and a sustain driving unit respectively including a sustain driving circuit for allowing a peaking pulse to be included in one sustain pulse in such a manner that a plurality of discharge is generated by means of one sustain pulse when a sustain pulse is applied to a predetermined electrode of the plasma display panel.

2. The plasma display apparatus as claimed in claim 1, wherein the predetermined electrode of the plasma display panel is at least one of a scan electrode and a sustain electrode.

3. The plasma display apparatus as claimed in claim 1, wherein the sustain driving circuit comprises:
a peaking pulse application unit having a switch for peaking pulse, which is turned on when energy of an energy storage unit is supplied to the plasma display panel, and a diode for injecting energy to the energy storage unit;
a resonant unit which forms a peaking pulse as LC resonance using the energy of the energy storage unit, and applies the formed LC resonance to the scan electrode or the sustain electrode; and
a sustain voltage controller that applies a sustain voltage to the scan electrode or the sustain electrode or sustains a ground level.

4. The plasma display apparatus as claimed in claim 1 or 4, wherein the peaking pulse is applied to the scan electrode or the sustain electrode before a sustain voltage is applied.

5. The plasma display apparatus as claimed in claim 1, wherein the switch for peaking pulse has a gate terminal that receives a timing signal, a drain terminal connected to the energy storage unit, and a source terminal connected to an anode terminal of the diode, and
the diode has a cathode terminal connected to the drain terminal of the switch for peaking pulse, and the anode terminal connected to the source terminal of the switch for peaking pulse.

6. The plasma display apparatus as claimed in claim 4, wherein a voltage of the peaking pulse is higher than the sustain voltage.

7. The plasma display apparatus as claimed in claim 3, wherein the resonant unit includes a coil, wherein the coil has one end connected to the source terminal of the switch for peaking pulse and the other end connected to the scan electrodes or the sustain electrodes.

8. The plasma display apparatus as claimed in claim 1, further comprising:
a load measurement unit for measuring the amount of load of picture data, which are converted to be suitable for the PDP, and comparing the amount of the measured load and the amount of reference load to output a voltage control signal; and
a voltage controller for controlling a sustain voltage according to the voltage control signal output from the load measurement unit, and applying the controlled sustain voltage to a scan electrode or a sustain electrode of the PDP.

9. The plasma display apparatus as claimed in claim 8, wherein the voltage controller applies a voltage higher than the sustain reference voltage to the scan electrode or the sustain electrode of the PDP if the amount of the measured load is higher than the amount of reference load.

10. The plasma display apparatus as claimed in claim 8, further comprising a sustain pulse controller for, if the amount of the measured load is higher than the amount of reference load, receiving a sustain pulse control signal from the load measurement unit, and controlling the number of sustain pulses, which is already allocated, wherein the sustain pulse controller controls the scan driving unit and the sustain driving unit to apply the sum of the reference sustain voltage and an increment value of the sustain voltage, when controlling the scan driving unit and the sustain driving unit to apply the sustain pulse to the scan electrode or the sustain electrode.

11. The plasma display apparatus as claimed in claim 8, wherein the voltage controller controls the reference sustain voltage to be applied to the scan electrode or the sustain electrode if the amount of the measured load is lower than the amount of reference load.

12. The plasma display apparatus as claimed in claim 8, 9 or 11, wherein the voltage controller includes a DC/DC converter, wherein the DC/DC converter decides the increment value of the sustain voltage according to a pulse width of a sustain voltage control signal.

13. A method of driving a plasma display apparatus, comprising the steps of:
converting an input picture signal to be suitable for a PDP, and forming picture data that are re-aligned on a sub-field basis;
measuring the amount of load using the picture data re-aligned on a sub-field basis, which are received from a controller unit;
comparing the amount of the measured load and the amount of reference load to output a voltage control signal; and
deciding a sustain voltage corresponding to the sustain voltage control signal, and applying the decided sustain voltage to a scan electrode or a sustain electrode of the PDP.

14. The method as claimed in claim 13, wherein if the amount of the measured load is higher than the amount of reference load, the number of sustain pulses that is already allocated is controlled.

15. The method as claimed in claim 13, further comprising the step of applying the reference sustain voltage to a scan electrode or a sustain electrode if the amount of the measured load is lower than the amount of reference load.

16. The method as claimed in claim 13, wherein the step of applying the decided sustain voltage to the scan electrode or the sustain electrode comprises the steps of:
while previously stored energy is injected, controlling a peaking pulse that is formed by way of LC resonance to be applied to the scan electrode;
after the peaking pulse is applied, controlling a sustain voltage to be applied to the scan electrode, and the sustain electrode to become a ground level;
while previously stored energy is injected, controlling the peaking pulse that is formed by way of LC resonance to be applied to the scan electrode; and
after the peaking pulse is applied, controlling a sustain voltage to be applied to the sustain electrode, and the scan electrode to become a ground level.

17. The method as claimed in claim 16, wherein the sustain voltage is applied when a voltage of the peaking pulse reaches a highest value.

18. The method as claimed in claim 16, wherein a voltage of the peaking pulse is higher than the sustain voltage.

19. The method as claimed in claim 16 or 18, wherein discharges are generated by the peaking pulse.
